(19) United States
(12) Patent Application Publication
(10) Pub. No.: US 2001/0033567 A1
(43) Pub. Date: Oct. 25, 2001

(54) Device for providing services and for transmission of data in the home

(76) Inventor: Robert Frati, Vienne (FR)

Correspondence Address: HESLIN ROTHENBERG FARLEY & MESITI PC, 5 COLUMBIA CIRCLE, ALBANY, NY, 12203, US

(21) Appl. No.: 09/862,959

(22) Filed: May 22, 2001

Related U.S. Application Data
(63) Continuation of application No. PCT/FR00/02632, filed on Sep. 22, 2000.

(30) Foreign Application Priority Data
Sep. 23, 1999 (FR) 99.12101

(51) Int. Cl. H04L 12/56

(52) U.S. Cl. 370/352; 370/401

(57) ABSTRACT

This device for providing services and for transmissions of data in the home, implements a plurality of peripheral modules (4-7) intended for measuring a specified quantity or for detecting a particular state.

It comprises a concentrator box (1) furnished with an electrical power supply, and incorporating:

a bidirectional radio modem (20), associated with an antenna (17) suitable for allowing the transmission and reception of radio waves within a specified perimeter bound for various peripheral modules (4-7);

a telephone modem (19), intended for allowing the transmission of data under an Internet-compatible protocol by way of a telephone network at the level of a remote server center (8), as well as the reception of data therefrom;

a processor (18) associated with a memory for storing software, which software is intended for making it possible to cater for radio communications, the extraction of the data arising from these communications and the shaping of the latter according to the protocol format suitable for allowing the communication of the data between the device and the server center, according to the protocol of the Internet network.

The invention relates to a device for providing services and for transmission of data in the home, and is therefore more particularly concerned with home automation.

More specifically, it is aimed at a system and a device which are capable of allowing the concentration of a certain number of items of information relating to the home in particular, and their transmission to a server centre which is capable, as a function of the information communicated to it, of bringing about, in addition to the transmission of information back, also the triggering of certain actions.

Various services existing in the home, such as in particular water, gas and electricity meters, alarm detection, etc., traditionally use their own network and are unable to share one and the same central point for dispatching information. They require an electrical power supply through the low voltage network or batteries, rechargeable or otherwise.

This results in a high sales price for the corresponding modules, in addition to the impossibility of the user upgrading his installation and/or supplementing it with new additional services.

These various services are traditionally made up of mutually independent modules, which can be interrogated at short distance by radio waves and therefore require an appropriate interrogation device for each of the said modules, thereby putting sigificant strain on the corresponding services.

The object of the invention is to circumvent these various drawbacks, by proposing in particular that the various information items from the various services of the home be concentrated within one and the same structure, and as a corollary, that this information be carried by the Internet network, hence at low cost, to an appropriate server centre.

According to another embodiment of the invention, the telephone communication is performed over the GSM network (Global System for Mobile Communication), that is to say according to the usual standard of so-called cellular telephone communications.

Finally, according to another embodiment, the exchange of data with the server centre is performed by way of local loops, that is to say a radio telephone network.

The way in which the invention may be embodied and the advantages which ensue will become more apparent from the exemplary embodiments which follow, given by way of nonlimiting indication in support of the appended figures.

FIG. 1 is a perspective diagrammatic representation of the box in accordance with the invention, in the embodiment of the type which can be mated with the switched telephone network.

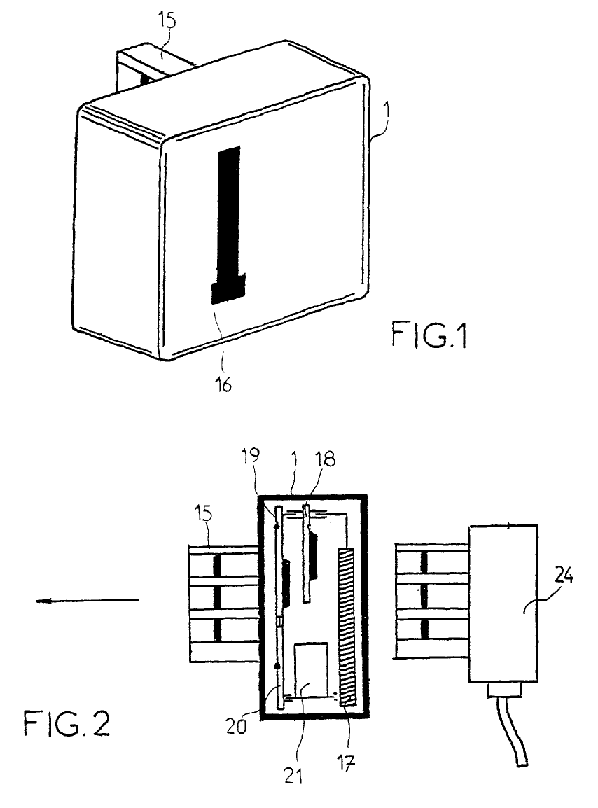

FIG. 2 is a cross sectional diagrammatic representation of the said box.

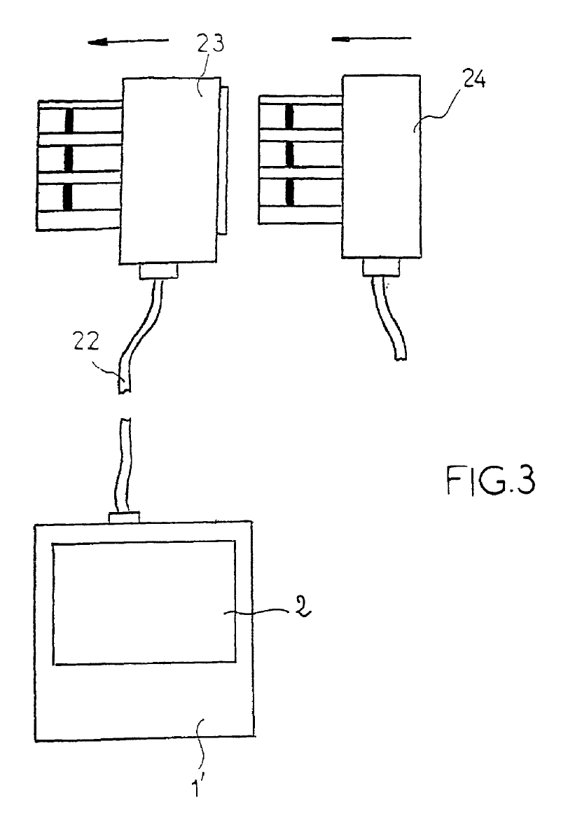

FIG. 3 is a further-upgraded embodiment than that represented in conjunction with FIGS. 1 and 2.

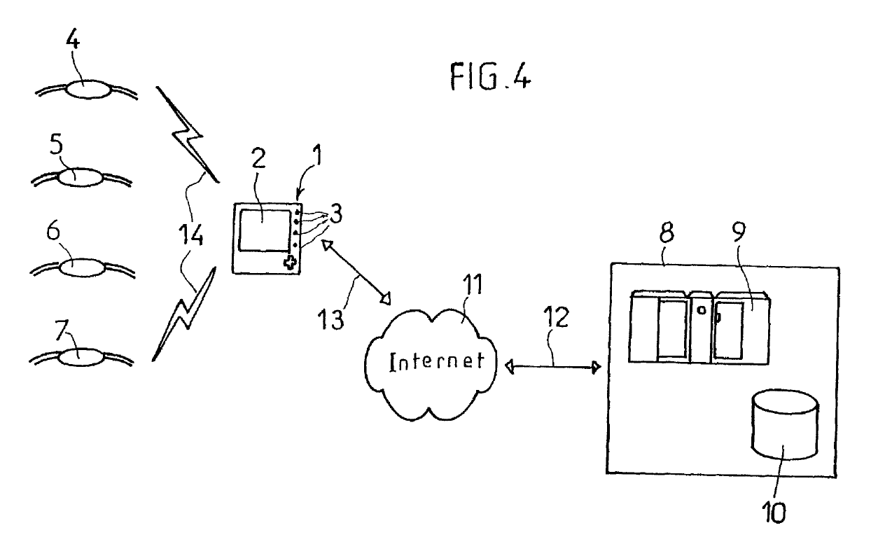

FIG. 4 is a diagrammatic representation of the operating principle of the device in accordance with the invention.

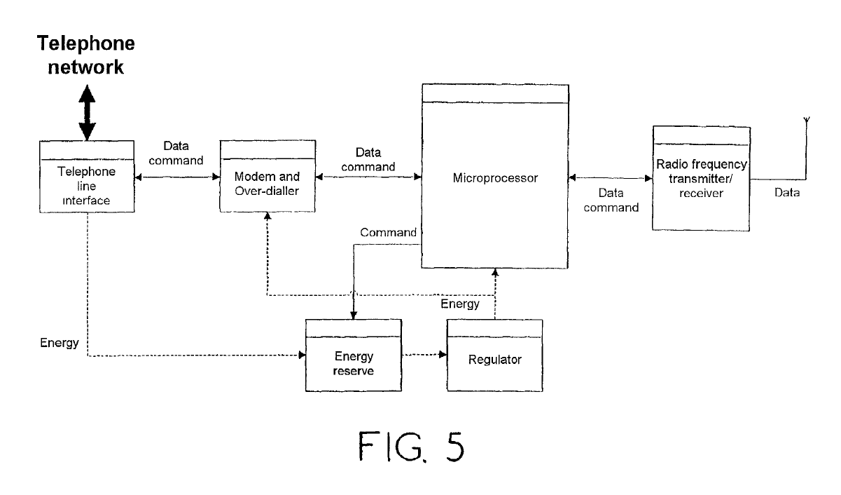

FIG. 5 is a diagrammatic representation of the operating concept of the concentrator box in accordance with the invention.

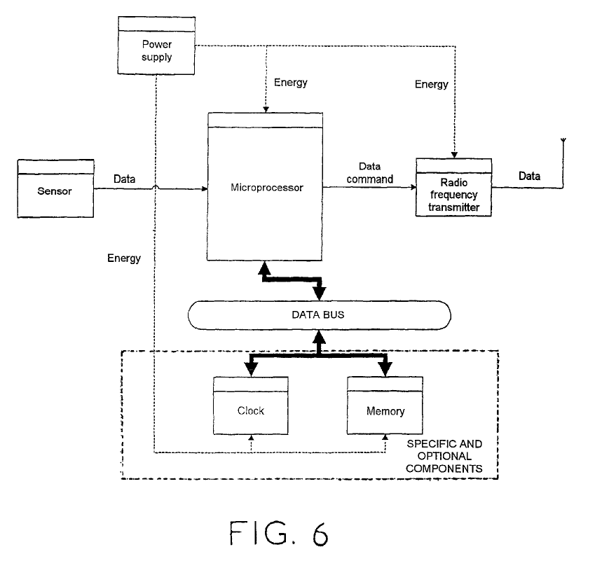

FIG. 6 is a diagrammatic representation of the operating concept of the peripheral modules, implemented within the framework of the present invention.

The operating principle of the device in accordance with the invention has been represented in conjunction with FIG. 4.

As already stated, the latter device is intended to allow the provision of services in the home, these services being of an informative or even decisional kind.

By way of nonlimiting example, these services may be the following. They may involve the implementation of sensors (4), (5), (6), (7), catering respectively for:

the reading of meters (water, gas, electricity, heating etc.);

the reading of the level of tanks (fuel oil, gas, LPG etc.);

power outage detection;

detection of break-ins;

smoke or fire detector;

distress alarm.

Each of these sensors (4), (5), (6), and (7) is self-powered, for example by means of a lithium battery or cell. They are each fitted with a radio module, capable of transmitting in monodirectional radio frequency mode bound for the concentrator box (1) described hereinbelow in greater detail.

They are advantageously fitted with a motherboard or microprocessor catering for, in addition to the processing of the signals transmitted by the sensor, with a view to allowing their communication by radio, also energy management (battery, cell), as well as the preparation of the frames for the transmission in radio mode of the information relating to them at the level of the concentrator box (1).

Transmission is performed, as already stated, in radio frequency mode, such as in particular in the standardized 433 MHz or 868 MHz bands. Obviously, the indication of these frequencies is in no way limiting as regards the scope of the present invention.

Represented in conjunction with FIG. 6 is the conceptual diagram of the operation of these peripheral modules (4-7).

The function of the box (1) is at least, the concentration of the information emanating from these modules (4-7), hence its name concentrator box. It will now be described in greater detail.

Basically, it is furnished with a source of energy or, with a facility able to store energy.

In the embodiment represented in conjunction with FIGS. 1 and 2, the said concentrator box (1) will be inserted by way of a plug (15) into a jack of the well-known switched telephone network.

As is known, a low-voltage, low-amperage current flows around the switched telephone network, and can be stored at the level of a capacitor (21) associated with a chopped power supply, linked electrically to the conducting tracks of the plug (15) with which the box is fitted.

This capacitor is dimensioned in such a way as to be able to have sufficient energy to allow the other facilities, especially modems with which the box is fitted, to operate.

This concentrator box (1) actually comprises firstly a telephone modem (19), powered with the electrical energy drawn from the telephone line of the switched network and stored in the capacitor (21). This modem is intended, in a known manner, to allow via an interface with the telephone line, the transmission of information or of data by means of the switched telephone network to which the said box is wired.

The latter also comprises a bidirectional radio modem (20), likewise powered from the electrical energy drawn from the telephone line and stored in the said storage facility, and in this instance the capacitor (21).

It comprises an antenna (17), intended for allowing communication in radio frequency mode between the radio modem (20) and the various peripheral modules (4) to (7).

Finally, it is fitted with a processor board +memory (18), whose functions are the following.

The memory stores one or more pieces of software, intended firstly to allow the detection of communication in radio frequency mode within the specified perimeter of the home, typically some one hundred meters.

Moreover, one at least of the pieces of software which it incorporates is intended to allow the extraction of the data arising from the said radio frequency waves thus picked up, or conversely, the shaping of information intended to be transmitted in radio frequency mode by the antenna at the level of the peripheral modules concerned (4-7).

Finally, and above all, it is intended to allow the shaping of the data according to a format compatible with an Internet protocol, and in particular the communication protocols:

PPP/PAP;

IP;

UDP.

These communication protocols are entirely known, so that there is no need to describe them here in detail. They are intended to allow the shaping of the information according to the format suitable for allowing the communication of data over the Internet network.

In fact, and in the example described, the telephone modem (19) is equipped with an IP (Internet protocol) address suitable for allowing the use of the Internet portal in this manner.

In this regard, the operating software stored in the memory associated with the processor (18) is updated remotely by way of the Internet portal in such a way as to thereby allow the upgradeability of the services in the home.

Therefore, the concentrator box (1) is able to communicate via the Internet network (11) by means of the telephone line (13) to which it is connected, and also by means of an Internet communication line (12) at the level of a server centre represented by the general reference (8), incorporating for example the server proper (9) as well as a database (10).

This server centre can be equipped moreover With a man/machine interface, with an Internet interface, etc. and its activity is obviously linked in this instance with the services of the home.

In addition to a billing service, registering the consumption of energies available in the home, it can also incorporate a distribution service, in particular for filling tanks for example, and also a service for diverting the user's telephone communications with choice of cheapest operator depending on destinations and on time slot.

In the first embodiment described, the concentrator box (1) comprises a jack (16) into which it will be possible to insert the user's telephone plug (24).

The conceptual diagram of this box has been represented in conjunction with FIG. 5.

In a further-upgraded version, described in conjunction with FIG. 3, the concentrator box (1′) is off-site, that is to say not directly positioned on the telephone plug. It can for example be fixed on a wall or a partition.

Under this hypothesis, it is joined by a wire link (22) to a plug/jack (23) which will be inserted into the telephone jack of the switched telephone network, and into which will in turn be inserted the plug (24) of the telephone of the user.

Furthermore, it can be fitted with a screen (2), able to allow the displaying of information of the type concerning consumption, maintenance, etc., arising from the peripheral modules (4-7) or from the server centre (8).

Represented by the reference (3) is a set of push-buttons, capable of being activated by the user within the framework of an interaction, in particular with the server centre (8), so as, for example, to concur with a proposal transmitted by this centre with a view to the detection of data at the level of the peripheral modules (4-7), which proposal is displayed on the screen. Such a proposal may for example consist in the filling of the fuel oil tank, the effecting of the maintenance service, etc. In the diagram, these push-buttons are 4 in number and make it possible respectively to concur with the said proposal, to raise or lower a cursor, and to return to the home page, for example.

In another embodiment of the invention, the telephone network implemented is no longer the switched telephone network but the GSM network. Under this hypothesis, the conventional telephone modem (19) is replaced with a GSM modem at the level of the said box, under this hypothesis, off-site.

Given the fact that the said box is then no longer supplied with energy by the switched telephone network, either the latter is fitted either with a battery, or it is connected to the low-voltage domestic electrical power mains.

In another embodiment of the invention, the concentrator box (1) communicates with the server centre (8) not now by way of the GSM network but by way of the local loop network, that is to say a telephone network operating by radio, developed recently at the level of relatively small inhabited areas, such as villages or districts, with the aim of minimizing the connection engineering.

The GSM modem or the conventional modem (19) is under this hypothesis replaced with a modem suited to the local loop network.

The device according to the invention therefore exhibits numerous advantages. It is firstly appreciated that, given the character of proximity of the communications by radio waves between the peripherals and the concentrator box, and the restricted volume of data thus transmitted, a system which consumes little energy is made available, thus allowing the use, obviously within the limits fixed by the law, of the energy of the telephone line of the switched telephone network or, of low-power and hence long-life batteries.

Moreover, a system is made available which sanctions the uniqueness of the point of communication, in this instance the concentrator box, which receives the general data for the various services described above.

In addition to the latter, or when it is fitted with the display screen (2), it can also receive predefined information, such as weather forecasts, stock market prices, electronic discount vouchers, interventional communication coming from various providers, etc.

Moreover, as the concentrator box is of restricted size, typically 7×7×3 cm, it proves to be compact and easily accessed.

1. Device for providing services and for transmissions of data in the home, implementing a plurality of peripheral modules (4-7) intended for measuring a specified quantity or for detecting a particular state, characterized in that it comprises a concentrator box (1) furnished with an electrical power supply, and incorporating:
a bidirectional radio modem (20), associated with an antenna (17) suitable for allowing the transmission and reception of radio waves within a specified perimeter bound for various peripheral modules (4-7);
a telephone modem (19), intended for allowing the transmission of data under an Internet-compatible protocol by way of a telephone network at the level of a remote server centre (8), as well as the reception of data therefrom;
a processor (18) associated with a memory for storing software, which software is intended for making it possible to cater for radio communications, the extraction of the data arising from these communications and the shaping of the latter according to the protocol format suitable for allowing the communication of the data between the device and the server centre, according to the protocol of the Internet network.

2. Device for providing services and for transmission of data in the home according to claim 1, characterized in that the telephone modem (19) is equipped with an IP address (Internet Protocol) suitable for allowing the use of the Internet portal.

3. Device for providing services and for transmission of data in the home according to claim 2, characterized in that the operating software stored in the memory associated with the processor (18) is updated remotely by way of the Internet portal, in such a way as to allow the upgradeability of the services in the home.

4. Device for providing services and for transmissions of data in the home according to one of claims 1 to 3, characterized in that the concentrator box (1) can be mated with a standard telephone plug linked to the switched telephone network, and in that it comprises a facility (21) for storing electrical energy conveyed by the said switched telephone network to which the said plug is wired.

5. Device for providing services and for transmission of data in the home according to claim 4, characterized in that the concentrator box (1) is also fitted with a jack (16) into which it will be possible to insert the user's telephone plug.

6. Device for providing services and for transmission of data in the home according to one of claims 1 to 3, characterized in that the concentrator box (1) is linked indirectly to the switched telephone network, and in that it comprises a facility (21) for storing electrical energy conveyed by the said switched telephone network to which the said plug is wired.

7. Device for providing services and for transmission of data in the home according to one of claims 4 to 6, characterized in that the facility for storing electrical energy consists of a capacitor (21) linked electrically to the conducting tracks of the plug (15) with which the box (1) is fitted.

8. Device for providing services and for transmission of data in the home according to one of claims 1 to 3, characterized in that the concentrator box is linked to the GSM network by means of a GSM dedicated modem.

9. Device for providing services and for transmission of data in the home according to one of claims 1 to 3, characterized in that the concentrator box (1) is linked to a radio telephone network of the “local loop” type by means of a modem dedicated to such a network.

10. Device for providing services and for transmission of data in the home according to one of claims 1 to 9, characterized in that the concentrator box furthermore comprises a screen (2), able to allow the displaying of information of the type concerning consumption, maintenance, etc., arising from the peripheral modules (4-7) or from the server centre (8).

11. Device for providing services and for transmission of data in the home according to one of claims 1 to 10, characterized in that the services provided are included within the group comprising:
the routing of telephone communications to the cheapest telephone operator;
the reading of water, gas and electricity meters, the said meters being themselves fitted with a transmitting and receiving antenna for radio waves compatible with the waves emitted by the radio modem;
the reading of heating meters;
the gauging of the levels of fuel oil and gas tanks and other fluid storage vessels;
the monitoring of intrusion protection systems;
the monitoring of smoke and/or fire detection systems;
distress alarm for the elderly;
the monitoring of the electrical power supply to freezers and/or refrigerators;
specialized communication to a mobile displayer of predefined information.
